(19) United States
(12) Patent Application Publication
(10) Pub. No.: US 2022/0157042 A1
(43) Pub. Date: May 19, 2022

(54) CONTROL APPARATUS, CONTROL METHOD, AND NON-TRANSITORY COMPUTER READABLE MEDIUM STORING PROGRAM

(71) Applicant: NEC Corporation, Minato-ku, Tokyo (JP)

(72) Inventor: Yosuke IWAMATSU, Tokyo (JP)

(73) Assignee: NEC Corporation, Minato-ku, Tokyo (JP)

(21) Appl. No.: 17/439,502

(22) PCT Filed: Mar. 25, 2019
(86) PCT No.: PCT/JP2019/012620

§ 371 Date: Sep. 15, 2021

(51) Int. Cl. G06V 10/62; G06V 10/26; G06V 10/764; G06T 7/215; G06T 7/70

(52) U.S. Cl. CPC G06V 10/62; G06V 10/26; G06V 2201/07; G06T 7/215; G06T 7/70; G06V 10/764

(57) ABSTRACT

A control unit (11) of a control apparatus (10) determines a “usage dividing position” from among a plurality of dividing position candidates based on the number of the substream data series for which the tracking continuity is lost when the “stream data series to be divided” is divided at each of the plurality of the “dividing position candidates” that differ from one another. The dividing unit (12) divides the “stream data series to be divided” at the “usage diving position” determined by the control unit (11) to thereby form the “divided data series”.

### TECHNICAL FIELD

The present disclosure relates to a control apparatus, a control method, and a non-transitory computer readable medium storing a program.

### BACKGROUND ART

A technique related to distributed processing has been proposed (e.g. Patent Literature 1). In the technique disclosed in Patent Literature 1, a plurality of divided videos obtained by dividing time-series data (video data) are executed in parallel by a plurality of analytics units. In the technique disclosed in Patent Literature 1, overlapped regions (overlapped frames) are provided to partial videos that are temporally adjacent to each other, thereby suppressing degradation in the analytics precision that may possibly occur due to the division of the videos.

### CITATION LIST

### Patent Literature

Patent Literature 1: Japanese Patent No. 3785068

### SUMMARY OF INVENTION

### Technical Problem

Incidentally, research and development as well as widespread use of a technique for tracking and analyzing a target object captured and included in an image and detecting suspicious behavior or the like of the target object have been promoted.

The inventors of the present disclosure have found that merely by providing the overlapped regions (the overlapped frames) to the partial videos that are temporally adjacent to each other as disclosed in Patent Literature 1, there is a possibility that degradation in the analytics precision cannot be suppressed in a case where the data to be analyzed is continuous data over a relatively long period of time such as when a target object is being tracked.

An object of the present disclosure is to provide a control apparatus, a control method, and a non-transitory computer readable medium storing a program that are capable of dividing the stream data series to be divided while suppressing degradation in the analytics precision.

### Solution to Problem

A control apparatus according to a first aspect of the present disclosure is a control apparatus configured to send out divided data series obtained by dividing stream data series to be divided to any of a plurality of analysis apparatuses,

in which the stream data series to be divided includes at least one substream data series, the respective substream data series including information related to an object to be tracked,

the control apparatus including:

a control unit configured to determine a usage dividing position from among a plurality of dividing position candidates based on the number of the substream data series for which the continuity of the tracking is lost when the stream data series to be divided is divided at each of the plurality of the dividing position candidates that differ from one another; and

a dividing unit configured to divide the stream data series to be divided at the determined usage dividing position to thereby form the divided data series.

A control method according to a second aspect is a control method executed by a control apparatus configured to send out divided data series obtained by dividing stream data series to be divided to any of a plurality of analysis apparatuses,

wherein the stream data series to be divided includes at least one substream data series, the respective substream data series including information related to an object to be tracked; and

wherein the method comprises:

determining a usage dividing position from among a plurality of dividing position candidates based on the number of the substream data series for which the continuity of the tracking is lost when the stream data series to be divided is divided at each of the plurality of the dividing position candidates that differ from one another; and

dividing the stream data series to be divided at the determined usage dividing position thereby forming the divided data series.

A non-transitory computer-readable medium according to a third aspect stores a program for causing a control apparatus configured to send out divided data series obtained by dividing stream data series to be divided to any of a plurality of analysis apparatuses to perform the processes,

wherein the stream data series to be divided includes at least one substream data series, the respective substream data series including information related to an object to be tracked; and

wherein the processes comprises:

determining a usage dividing position from among a plurality of dividing position candidates based on the number of the substream data series for which the continuity of the tracking is lost when the stream data series to be divided is divided at each of the plurality of the dividing position candidates that differ from one another; and

dividing the stream data series to be divided at the determined usage dividing position thereby forming the divided data series.

### Advantageous Effects of Invention

According to the present disclosure, a control apparatus, a control method, and a non-transitory computer readable medium storing a program that are capable of dividing the stream data series to be divided while suppressing degradation in the analytics precision can be provided.

### BRIEF DESCRIPTION OF DRAWINGS

FIG. 1 is a block diagram showing an example of a control apparatus according to a first example embodiment;

FIG. 2 is a block diagram showing an example of an analysis system according to a second example embodiment;

FIG. 3 is a block diagram showing an example of a control apparatus according to the second example embodiment;

FIG. 4 is a diagram used to describe counting of the number of the substream data series for which the tracking continuity is lost;

FIG. 5 is a diagram showing an example of a correspondence relationship between the number of the substream data series to be fragmented and the analysis precision;

FIG. 6 is a diagram showing an example of a result of calculation of the analysis precision

FIG. 7 is a diagram showing an example of a correspondence relationship between the analysis precision and the demand sufficiency level;

FIG. 8 is a diagram showing an example of a result of calculation of the sufficiency level of the analysis precision;

FIG. 9 is a flowchart showing an example of operation processing of the control apparatus according to the second example embodiment;

FIG. 10 is a block diagram showing an example of a control apparatus according to a third example embodiment;

FIG. 11 is a diagram showing an example of a correspondence relationship between the time length candidates and the sufficiency level satisfied by the response time in accordance with the time length candidates in an analysis apparatus;

FIG. 12 is a diagram showing an example of a result of calculation of the sufficiency level of the response time;

FIG. 13 is a diagram used to describe calculation of a total sufficiency level;

FIG. 14 is a flowchart showing an example of operation processing of the control apparatus according to the third example embodiment; and

FIG. 15 is a diagram showing an example of a hardware configuration of a control apparatus.

### DESCRIPTION OF EMBODIMENTS

Hereinbelow, example embodiments of will be described with reference to the drawings. Note that in the example embodiments, the same or the equivalent elements are denoted by the identical reference symbols and redundant explanation thereof is omitted.

### First Example Embodiment

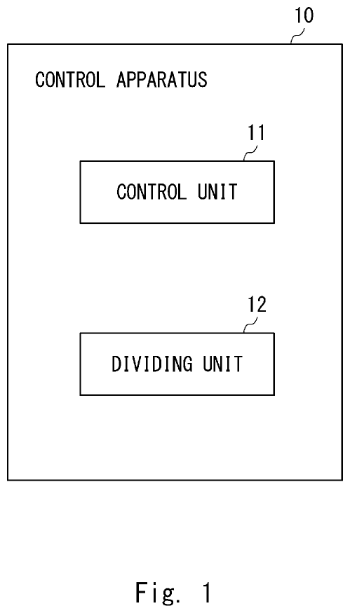

FIG. 1 is a block diagram showing an example of a control apparatus according to a first example embodiment. A control apparatus (an analytical load balancer) 10 shown in FIG. 1 sends out each of the “divided data series” obtained by dividing the “stream data series to be divided” to any of a plurality of analysis apparatuses (not shown). By this configuration, the analytical processing of the stream data series is performed by the distributed processing performed by the plurality of the analysis apparatuses (not shown). Here, “the stream data series to be divided” includes at least one substream data series, the respective substream data series including information related to the “object to be tracked (hereinbelow also referred to as the “tracked object”. The “object to be tracked” is, for instance, a movable object such as human or an automobile.

The control apparatus (the analytical load balancer) 10 shown in FIG. 1 includes a control unit 11 and a dividing unit 12.

The control unit 11 counts the number of the substream data series for which the tracking continuity is lost when the “stream data series to be divided” is divided at each of the plurality of the “dividing position candidates” that differ from one another. Then, the control unit 11 determines the “usage dividing position” from among the plurality of the dividing position candidates based on the counted number of the substream data series.

The dividing unit 12 divides the “stream data series to be divided” at the “usage dividing position” determined by the control unit 11 to thereby form the “divided data series”. The divided data series thus formed is sent out to any of the plurality of the analysis apparatuses (not shown) described above.

As described above, according to the first example embodiment, the control unit 11 of the control apparatus (the analytical load balancer) 10 determines the “usage dividing position” from among the plurality of the dividing position candidates based on the number of the substream data series for which the tracking continuity is lost when the “stream data series to be divided” is divided at each of the plurality of the “dividing position candidates” that differ from one another. The dividing unit 12 divides the “stream data series to be divided” at the “usage diving position” determined by the control unit 11 to thereby form the “divided data series”.

By the configuration of the control apparatus 10 described above, it is possible to determine the “usage dividing position” used for dividing the “stream data series to be divided” based on the “number of the substream data series for which the tracking continuity is lost” that serves as an index of precision of analysis performed using the “divided data series”. This makes it possible to divide the stream data series to be divided while suppressing degradation in the analytics precision.

### Second Example Embodiment

A second example embodiment relates to a more specific example embodiment.

<Outline of Analysis System>

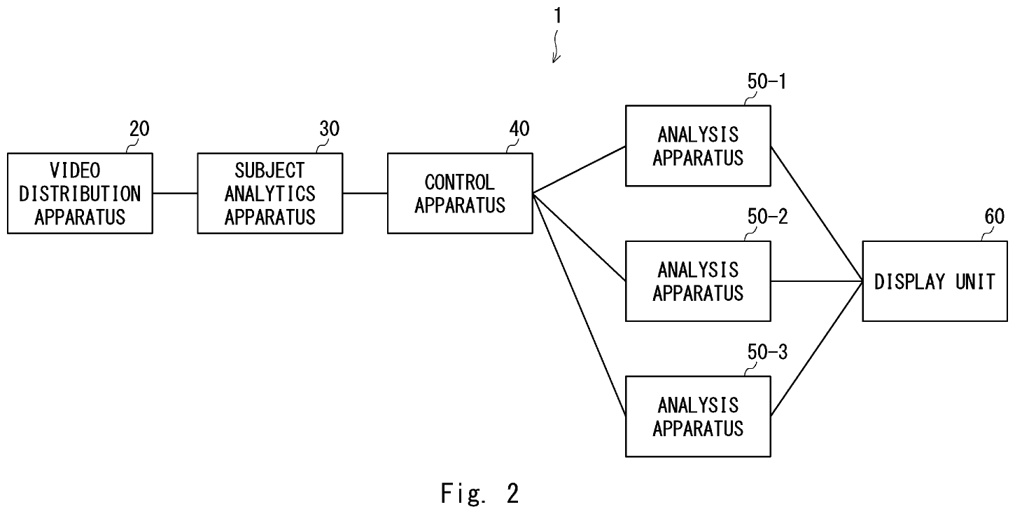

FIG. 2 is a block diagram showing an example of an analysis system according to the second example embodiment. In FIG. 2, an analysis system 1 includes a video distribution apparatus 20, a subject analytics apparatus 30, a control apparatus (an analytical load balancer) 40, analysis apparatuses 50-1, 50-2, and 50-3, and a display apparatus 60. The analysis apparatuses 50-1, 50-2, and 50-3 may be physically installed machines or may be, for instance, a virtual machine configured on the cloud. Hereinbelow, when the analysis apparatuses 50-1, 50-2, and 50-3 are not distinguished, each of the analysis apparatuses 50-1, 50-2, and 50-3 is simply referred to as the analysis apparatus 50. Note that in FIG. 2, the number of the analysis apparatuses 50 connected to the control apparatus 40 is three, however it is not limited thereto, and a plurality of the analysis apparatuses 50 may be connected to the control apparatus 40. Further, one set of the video distribution apparatus 20, the subject analytics apparatus 30, and the control apparatus 40 is shown in FIG. 2, however the analysis system 1 may include more than one set.

The video distribution apparatus 20 is, for instance, a shooting camera, and sequentially sends out the video (the image frame) capturing the area to be shot to the subject analytics apparatus 30. That is, the video distribution apparatus 20 sends out the plurality of the image frames in time series to the subject analytics apparatus 30.

The subject analytics apparatus 30 identifies the “tracked object” in each image frame received from the video distribution apparatus 20 and sends out the “data unit (the sensing data unit)” including information related to the “tracked object” identified in each image frame to the control apparatus 40. The “data unit” group to be sequentially sent out from the subject analytics apparatus 30 can be referred to as the “stream data series”.

When a plurality of the tracked objects are included in the corresponding image frame, each “data unit” includes information related to each of the plurality of the tracked objects. The information related to each “tracked object” includes, for instance, information related to at least an identifier and the location of the instant tracked object. Further, the information related to each “tracked object” may further include a “tracking start flag” of the instant tracked object. Further, the information related to each “tracked object” may further include a “tracking end flag” of the instant tracked object. The tracking start flag of each tracked object is included in the data unit corresponding to the first image frame that includes the instant tracked object. Further, the tracking end flag of each tracked object is included in the data unit corresponding to the last image frame that includes the instant tracked object.

Here, the information related to one tracked object included across the plurality of data units can be referred to as the “substream data series”. The one substream data series indicates at least the trajectory of the location of the tracked object in the area to be shot.

The control apparatus 40 receives the “stream data series” from the subject analytics apparatus 30 and divides the “stream data series to be divided” which is a part of the “stream data series” into a plurality of the “divided data series”. Then, the control apparatus 40 sends out the obtained plurality of the divided data series to any of the analysis apparatuses 50-1, 50-2, and 50-3. The control apparatus 40 will be described later in detail.

Each analysis apparatus 50 analyzes the “tracked object” using the “divided data series” received from the control apparatus 40 and sends out the result of the analysis to the display apparatus 60. For instance, the analysis apparatus 50 analyzes the tracked object using the “divided data series” and detects that the tracked object is a person staying in the area to be shot. By this configuration, for instance, it is possible to detect one who has come to check out the place where he/she is going to commit a crime, whereby it is possible to detect a sign of the crime at an early stage.

The display apparatus 60 displays the result of the analysis received from the analysis apparatus 50.

<Example of Configuration of Control Apparatus>

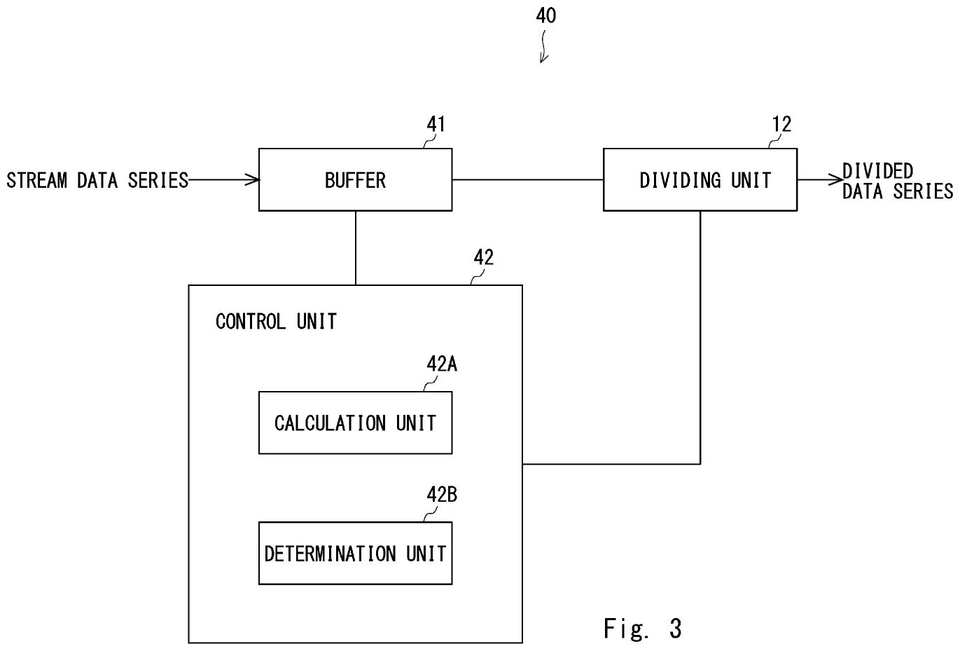

FIG. 3 is a block diagram showing an example of a control apparatus according to the second example embodiment. The control apparatus 40 shown in FIG. 3 includes a buffer 41, a control unit 42, and the dividing unit 12. The control unit 42 includes a calculation unit 42A and a determination unit 42B.

The buffer 41 temporarily holds the “stream data series” received from the subject analytics apparatus 30 and outputs the data to the dividing unit 12 in units of the “stream data series to be divided”.

The calculation unit 42A calculates the index of the analysis precision estimated for the divided data series corresponding to each of the dividing position candidates based on the number of the substream data series for which the tracking continuity is lost when the “stream data series to be divided” is divided at each dividing position candidate. Hereinbelow, this index is also referred to as the “precision index”. This “precision index” may be the analysis precision itself or may be the sufficiency level (hereinafter also referred to as the “first sufficiency level”) of the analysis precision in which the analysis precision satisfies the “precision demand”.

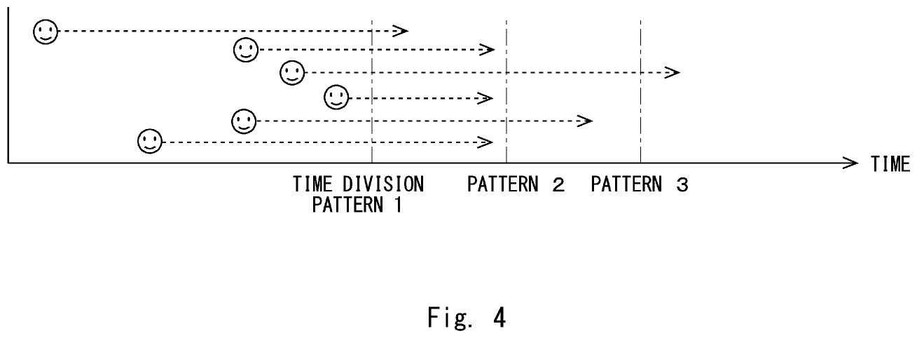

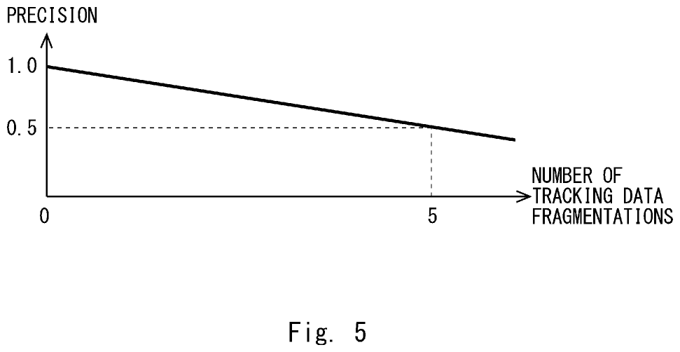

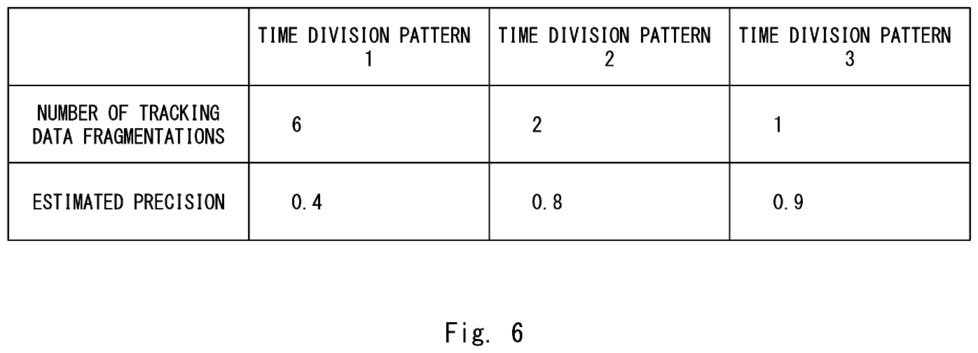

For instance, the calculation unit 42A counts the number of the substream data series for which the tracking continuity is lost when the “stream data series to be divided” is divided at each of the plurality of the “dividing position candidates” that differ from one another (the number of the objects to be tracked for which the tracking continuity is lost, the number of tracking data fragmentations). FIG. 4 is a diagram used to describe counting of the number of the substream data series for which the tracking continuity is lost. In FIG. 4, each arrow shown by the dotted lines indicates the substream data series. Further, in FIG. 4, three dividing position candidates are shown as the time division patterns 1, 2, and 3. In FIG. 4, six substream data series are fragmented in the time division pattern 1, two substream data series are fragmented in the time division pattern 2, and one substream data series is fragmented in the time division pattern 3. Here, each dividing position candidate serves as a boundary between the two continuous data units. In the case where the above-mentioned tracking end flag is used, the calculation unit 42A calculates the number of the substream data series for which the tracking continuity is lost by subtracting the number of the substream data series to which the “tracking end flag” is added from the total number of the substream data series included in the data unit immediately before the dividing position candidate. Then, for instance, the calculation unit 42A calculates the “analysis precision” corresponding to each dividing position candidate based on the “correspondence relationship (hereinbelow also referred to as the “first correspondence relationship”)” of the number of the substream data series to be fragmented and the analysis precision and the counted number of the substream data series (the number of tracking data fragmentations). FIG. 5 is a diagram showing an example of a correspondence relationship between the number of the substream data series to be fragmented and the analysis precision. The correspondence relationship shown in FIG. 5 models the relationship between the number of the substream data series to be fragmented and the analysis precision based on, for instance, the past result data. Referring to the examples shown in FIGS. 4 and 5, the “analysis precision” corresponding to each dividing position candidate can be obtained as shown in FIG. 6. FIG. 6 is a diagram showing an example of a result of calculation of the analysis precision. As stated above, the “analysis precision” itself may be used as the “precision index”.

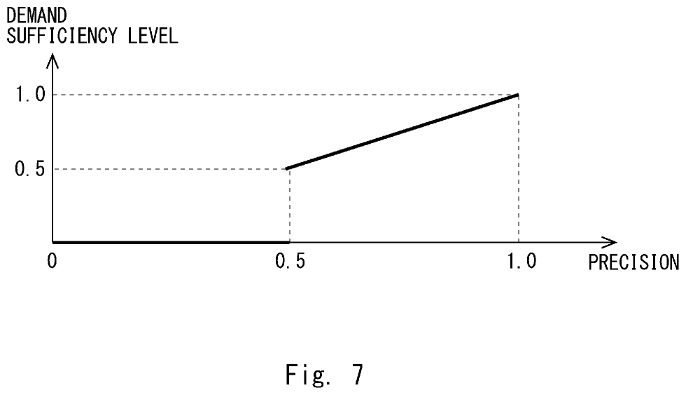

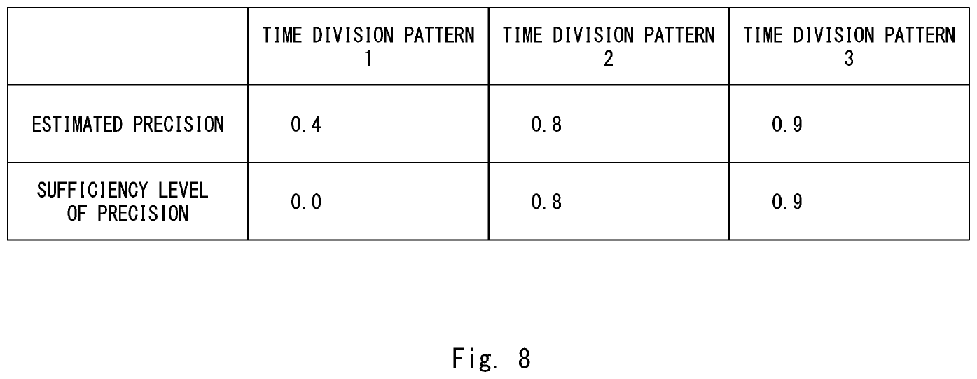

The calculation unit 42A may further calculate the sufficiency level (i.e. the first sufficiency level) in which the calculated analysis precision satisfies the “precision demand”. For instance, the calculation unit 42A may calculate the above-mentioned “first sufficiency level” based on the correspondence relationship between the analysis precision and the sufficiency level (hereinbelow also referred to as the “second correspondence relationship”) and the calculated analysis precision. FIG. 7 is a diagram showing an example of a correspondence relationship between the analysis precision and the demand sufficiency level. In the correspondence relationship model shown in FIG. 7, the sufficiency level corresponding to the analysis precision lower than 0.5 (the demand sufficiency level) is zero, and the analysis precision lower than 0.5 is not accepted. Referring to the examples shown in FIGS. 6 and 7, the “first sufficiency level” corresponding to each dividing position candidate can be obtained as shown in FIG. 8. FIG. 8 is a diagram showing an example of a result of calculation of the sufficiency level of the analysis precision. As described above, the “first sufficiency level” may be used as the “precision index”.

The determination unit 41B determines the usage dividing position from among the plurality of the dividing position candidates based on the “precision index” calculated by the calculation unit 42A. In the example shown in FIG. 8, the sufficiency level is the highest for the first sufficiency level of the time division pattern 3 and thus the dividing position candidate corresponding to the time division pattern 3 is selected as the usage dividing position.

The dividing unit 12 divides the “stream data series to be divided” received from the buffer 41 at the “usage dividing position” determined by the determination unit 41B and forms the “divided data series”.

<Example of Operation of Control Apparatus>

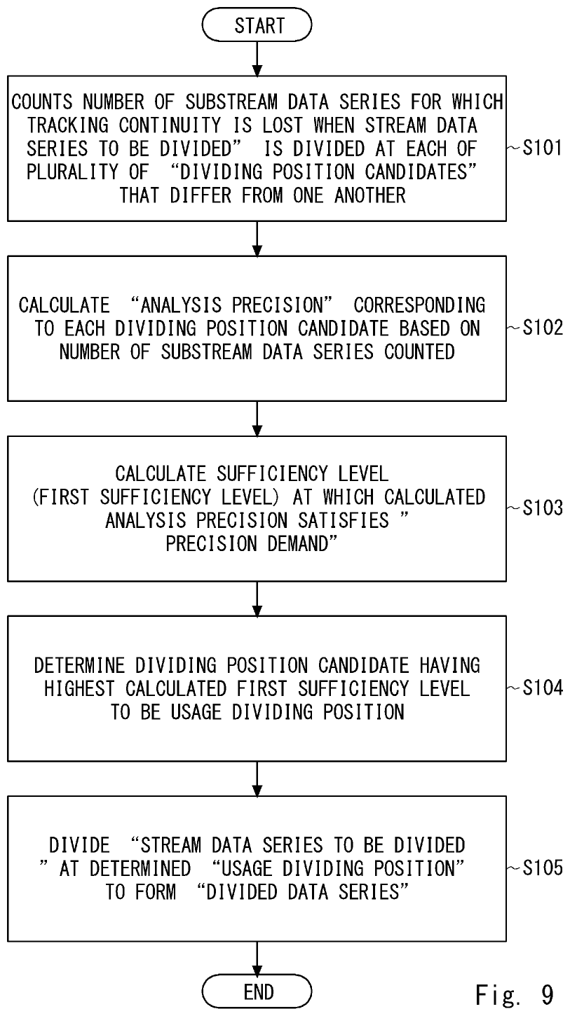

An example of operation processing of the control apparatus 40 having the above-mentioned configuration will be described. FIG. 9 is a flowchart showing an example of operation processing of the control apparatus according to the second example embodiment. The flow of processing shown in FIG. 9 is performed, for instance, every time the stream data series is accumulated for each data to be divided in the buffer 41.

The calculation unit 42A counts the number of the substream data series for which the tracking continuity is lost (the number of tracking data fragmentations) when the “stream data series to be divided” is divided at each of the plurality of the “dividing position candidates” that differ from one another (Step S101).

The calculation unit 42A calculates the “analysis precision” corresponding to each dividing position candidate based on the number of the substream data series counted (the number of tracking data fragmentations) (Step S102).

The calculation unit 42A calculates the sufficiency level (the first sufficiency level) at which the calculated analysis precision satisfies the “precision demand” (Step S103).

The determination unit 41B determines the dividing position candidate having the highest first sufficiency level calculated in Step S103 to be the usage dividing position (Step S104). The information related to the determined usage dividing position is output to the dividing unit 12. Then, the determination unit 41b causes the buffer 41 to output “the stream data series to be divided” to the dividing unit 12.

The dividing unit 12 divides the “stream data series to be divided” at the “usage dividing position” determined in Step S104 to thereby form the “divided data series” (Step S105).

As described above, according to the second example embodiment, in the control apparatus (the analytical load balancer) 40, the calculation unit 42A calculates the index of the analysis precision estimated for the divided data series corresponding to each of the dividing position candidates based on the number of the substream data series for which the tracking continuity is lost when the “stream data series to be divided” is divided at each of the plurality of the dividing position candidates that differ from one another. The determination unit 41B determines the usage dividing position from among the plurality of the dividing position candidates based on the calculated index.

By the configuration of the control apparatus 40 described above, it is possible to divide the stream data series to be divided while suppressing degradation in the analytics precision.

### Third Example Embodiment

A third example embodiment relates to an example embodiment in which the “usage dividing position” is determined based on a “total sufficiency level” that is based on the above-mentioned first sufficiency level and the “second sufficiency level”. The “second sufficiency level” is a sufficiency level satisfied by the “response time” in accordance with the time length of the divided data series in the analysis apparatus 50. Note that the basic configuration of the analysis system according to the third example embodiment is the same as that of the analysis system 1 according to the second example embodiment, and thus an explanation thereof is given by referring to FIG. 2. That is, the analysis system 1 according to the third example embodiment includes a control apparatus 70 to be described later in place of the control apparatus 40 shown in in FIG. 2.

<Example of Configuration of Control Apparatus>

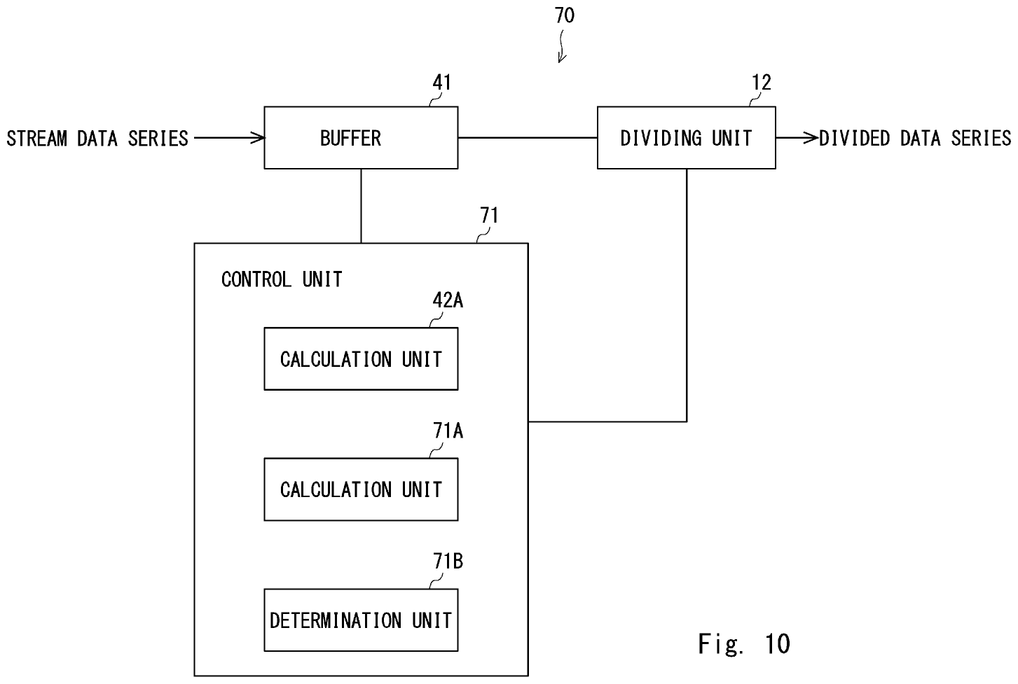

FIG. 10 is a block diagram showing an example of a control apparatus according to the third example embodiment. The control apparatus (the analytical load balancer) 70 shown in FIG. 10 includes the buffer 41, a control unit 71, and the dividing unit 12. The control unit 71 includes a calculation unit 41A, a determination unit 71A, and a determination unit 71B.

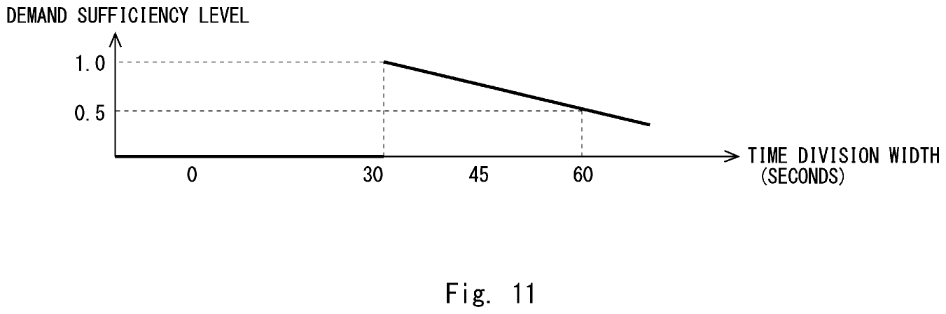

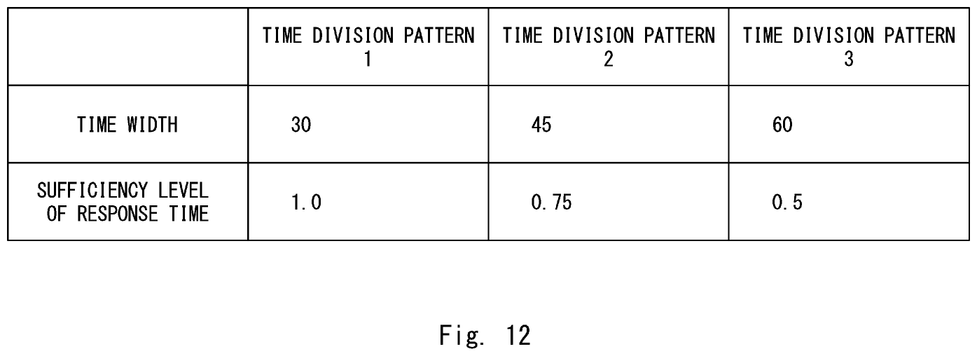

The calculation unit 71A calculates the sufficiency level (the second sufficiency level) satisfied by the “response time” in accordance with the time length of each divided data series (the time division width) of the “stream data series to be divided” at each diving position candidate in the analysis apparatus 50. For instance, the calculation unit 71A calculates the “second sufficiency level” of each divided data series based on the time length (the time division width) of each divided data series when the “stream data series to be divided” is divided at each dividing position candidate and the “second correspondence relationship”. The “second correspondence relationship” is the correspondence relationship between the plurality of the time length candidates and the sufficiency level (the second sufficiency level) satisfied by the “response time” in accordance with each time length candidate in the analysis apparatus 50. The “response time” in the analysis apparatus 50 is synonymous with the time taken for the analysis apparatus 50 to perform analyzing processing of the divided data series (that is, the delay time). Therefore, the longer the “response time” in the analysis apparatus 50, the lower the second sufficiency level tends to become. FIG. 11 is a diagram showing an example of a correspondence relationship between the time length candidates and the sufficiency level satisfied by the response time in accordance with the time length candidates in an analysis apparatus. In the example of the second correspondence relationship shown in FIG. 11, the second sufficiency level corresponding to the time length of less than 30 seconds is zero. That is, the second correspondence relationship shown in FIG. 11 is a model in which the time length of the divided data series less than 30 seconds is not accepted. And, in the example of the second correspondence relationship shown in FIG. 11, as the time length increases from 30 seconds, the second sufficiency level decreases. For instance, when the time length of the divided data series corresponding to each of the time division pattern 1, the time division pattern 2, and the time division pattern 3 is 30 seconds, 45 seconds, and 60 seconds, respectively, referring to the second correspondence relationship shown in FIG. 11, the second sufficiency level corresponding to each of the time division pattern 1, the time division pattern 2, and the time division pattern 3 is 1.0, 0.75, and 0.5, respectively as shown in FIG. 12. FIG. 12 is a diagram showing an example of a result of calculation of the sufficiency level of the response time.

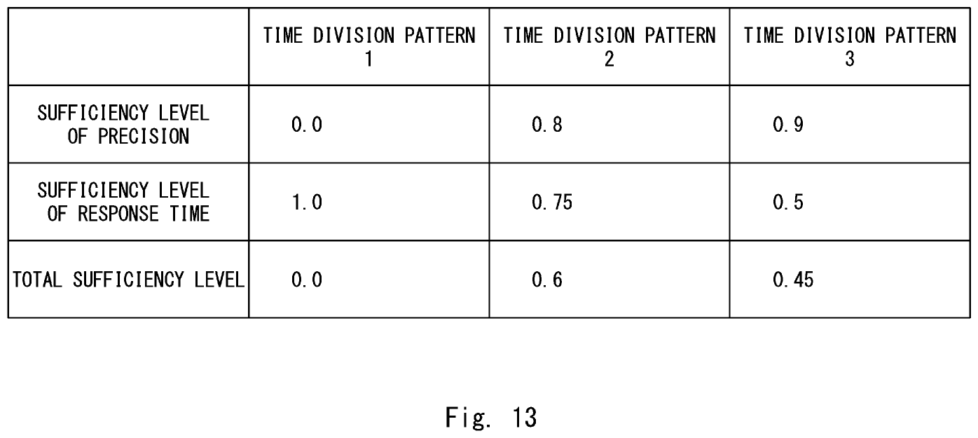

The determination unit 71B calculates the “total sufficiency level” for each dividing position candidate based on the first sufficiency level calculated by the calculation unit 42A and the second sufficiency level calculated by the calculation unit 71A for each of the dividing positon candidates. For instance, the “total sufficiency level” may be calculated by multiplying the first sufficiency level by the second sufficiency level. In the case of using such a method for calculating the total sufficiency level, the total sufficiency level is calculated as shown in FIG. 13 by referring to the examples shown in FIGS. 8 and 12. FIG. 13 is a diagram used to describe calculation of a total sufficiency level. Note that the method for calculating the total sufficiency level based on the first sufficiency level and the second sufficiency level is not limited to the aforementioned example and the total sufficiency level may be the result obtained by, for instance, applying a weigh addition to the first sufficiency level and the second sufficiency level.

Then, the determination unit 71B determines the usage dividing position from among the plurality of the dividing position candidates based on the plurality of the sufficiency levels calculated for the plurality of the dividing position candidates. Here, at the dividing position candidate at which the time length of the divided data series is shorter than those of the other dividing position candidates, the second sufficiency level tends to be higher than those of the other dividing position candidates. However, the first sufficiency level may be low depending on the number of tracking data fragmentations corresponding to the respective dividing position candidates. Therefore, by referring to the total sufficiency level as the index for determining the usage dividing position, it is possible to determine the usage dividing position at which the delay in the analyzing processing can be reduced while maintaining the analysis precision. In the example shown in FIG. 13, the analysis precision and the delay in the analyzing processing are well-balanced in the time division pattern 2 and thus the time division pattern 2 has the highest total sufficiency level, whereby the dividing position corresponding to the time division pattern 2 is selected as the used dividing position.

<Example of Operation of Control Apparatus>

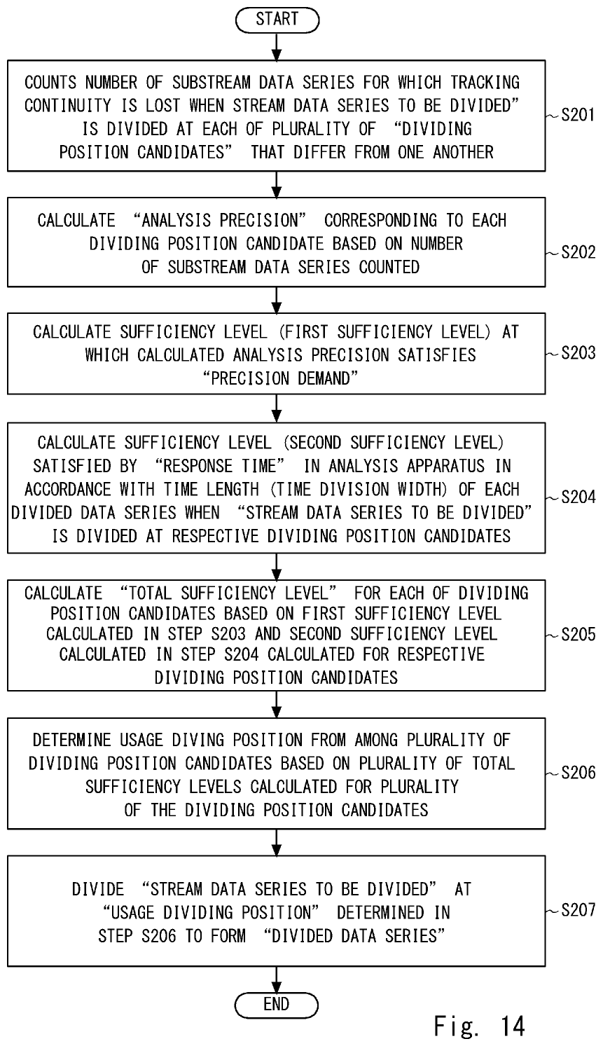

An example of operation processing of the control apparatus 70 having the above-mentioned configuration will be described. FIG. 14 is a flowchart showing an example of operation processing of the control apparatus according to the third example embodiment. The flow of processing shown in FIG. 14 is performed, for instance, every time the stream data series is accumulated for each data to be divided in the buffer 41.

Step S201 to Step S203 are respectively the same as Step S101 to Step S103 shown in FIG. 9.

The calculation unit 71A calculates the sufficiency level (the second sufficiency level) satisfied by “the response time” in the analysis apparatus 50 in accordance with the time length (the time division width) of each divided data series when the “stream data series to be divided” is divided at the respective dividing position candidates (Step S204).

The determination unit 71B determines the “total sufficiency level” for each of the dividing position candidates based on the first sufficiency level calculated in Step S203 and the second sufficiency level calculated in Step S204 calculated for respective dividing position candidates (Step S205).

The determination unit 71B determines the usage diving position from among the plurality of the dividing position candidates based on the plurality of the total sufficiency levels calculated for the plurality of the dividing position candidates (Step S206). Then, the determination unit 71B causes the buffer 41 to output the “stream data series to be divided” to the dividing unit 12.

The dividing unit 12 divides the “stream data series to be divided” at the “usage dividing position” determined in Step S206 to form the “divided data series” (Step S207).

As described above, according to the third example embodiment, in the control apparatus (the analytical load balancer) 70, the calculation unit 71A calculates the sufficiency level (the second sufficiency level) satisfied by the “response time” in the analysis apparatus 50 in accordance with the time length (the time division width) of each divided data series when the “stream data series to be divided” is divided at the respective dividing position candidates. The determination unit 71B calculates the “total sufficiency level” for each of the dividing position candidates based on the first sufficiency level calculated by the calculation unit 42A and the second sufficiency level calculated by the calculation unit 71A calculated for each of the dividing position candidates. The determination unit 71B determines the usage dividing position from among the plurality of the dividing position candidates based on the plurality of the total sufficiency levels calculated for the plurality of the dividing position candidates.

By the configuration of the control apparatus 70 described above, it is possible to determine the usage dividing position at which delay in the analyzing processing can be reduced while maintaining the analysis precision.

### Other Example Embodiments

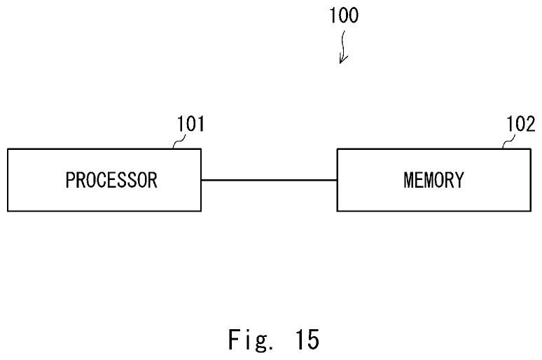

FIG. 15 is a diagram showing an example of a hardware configuration of a control apparatus. The control apparatus 100 shown FIG. 15 includes a processor 101 and a memory 102. The processor 101 may be, for instance, a microprocessor, a MPU (Micro Processing Unit), or a CPU (Central Processing Unit). The processor 101 may include a plurality of processors. The memory 102 may be configured of a combination of a volatile memory and a non-volatile memory. The memory 102 may include a storage disposed distant from the processor 101. In this case, the processor 101 may access the memory 102 via the unillustrated interface I/O.

Each of the control apparatuses 10, 40, and 70 according to the first example embodiment to the third example embodiment, respectively can include a hardware configuration shown in FIG. 15. The control units 11, 42, and 71 of the control apparatuses 10, 40, and 70 according to the first example embodiment to the third example embodiment and the dividing unit 12 may be realized by causing the processor 101 to load and implement the programs stored in the memory 102. The buffer 41 may be implemented by the memory 102. The program can be stored and provided to the control apparatuses 10, 40, and 70 using any type of non-transitory computer readable media. Examples of non-transitory computer readable media include magnetic storage media (such as floppy disks, magnetic tapes, hard disk drives, etc.), and optical magnetic storage media (e.g. magneto-optical disks). Further, examples of non-transitory computer readable media include CD-ROM (Read Only Memory), CD-R, and CD-R/W. Further, example of non-transitory computer readable media include semiconductor memories. Examples of semiconductor memories include mask ROM, PROM (Programmable ROM), EPROM (Erasable PROM), flash ROM, RAM (Random Access Memory). Further, the program may be provided to the control apparatuses 10, 40, and 70 using any type of transitory computer readable media. Examples of transitory computer readable media include electric signals, optical signals, and electromagnetic waves. Transitory computer readable media can provide the program to the control apparatuses 10, 40, and 70 via a wired communication line such as electric wires, and optical fibers or a wireless communication line.

The present disclosure has been described with reference to the example embodiments, however, the present disclosure is not limited thereto. The configuration and the details of the present disclosure can be modified in various ways that can be understood by one skilled in the art within the scope of the disclosure.

### REFERENCE SIGNS LIST

1 ANALYSIS SYSTEM
10 CONTROL APPARATUS (ANALYTICAL LOAD BALANCER)
11 CONTROL UNIT
12 DIVIDING UNIT
20 VIDEO DISTRIBUTION APPARATUS
30 SUBJECT ANALYTICS APPARATUS
40 CONTROL APPARATUS (ANALYTICAL LOAD BALANCER)
41 BUFFER
41A CALCULATION UNIT
41B DETERMINATION UNIT
42 CONTROL UNIT
42A CALCULATION UNIT
42B DETERMINATION UNIT
50 ANALYSIS APPARATUS
60 DISPLAY APPARATUS
70 CONTROL APPARATUS (ANALYTICAL LOAD BALANCER)
71 CONTROL UNIT
71A CALCULATION UNIT
71B DETERMINATION UNIT

What is claimed is:

1. A control apparatus configured to send out divided data series obtained by dividing stream data series to be divided to any of a plurality of analysis apparatuses,
the stream data series to be divided including at least one substream data series, the respective substream data series including information related to an object to be tracked,
the control apparatus comprising:
at least one memory configured to store instructions; and
at least one processor configured to execute, according to the instructions, a process comprising:
first determining a usage dividing position from among a plurality of dividing position candidates based on the number of the substream data series for which the continuity of the tracking is lost when the stream data series to be divided is divided at each of the plurality of the dividing position candidates that differ from one another; and
dividing the stream data series to be divided at the determined usage dividing position to thereby form the divided data series.

2. The control apparatus according to claim 1, wherein the first determining comprises:
first calculating an index related to analysis precision estimated for the divided data series corresponding to each of the plurality of the dividing position candidates based on the number of the substream data series for which the continuity of the tracking is lost; and
second determining the usage dividing position from among the plurality of the divided position candidates based on the calculated index.

3. The control apparatus according to claim 2, wherein the first calculating includes second calculating the analysis precision estimated for the divided data series corresponding to each of the plurality of the dividing position candidates based on the number of the substream data series for which the continuity of the tracking is lost, and third calculating, as the index, a first sufficiency level at which a precision demand is satisfied by the calculated analysis precision.

4. The control apparatus according to claim 3, wherein
the third calculating includes fourth calculating a second sufficiency level satisfied by the response time in the analysis apparatus in accordance with a time length of each of the plurality of the divided data series when the stream data series to be divided is divided at each of the plurality of the dividing position candidates; and
the second determining includes fifth calculating the total sufficiency level for each of the plurality of the dividing position candidates based on the first sufficiency level and the second sufficiency level calculated for each of the plurality of the dividing position candidates and third determining the usage dividing position from among the plurality of the dividing position candidates based on the plurality of the total sufficiency levels calculated for the plurality of the dividing position candidates.

5. The control apparatus according to claim 4, wherein
the stream data series to be divided includes a plurality of data units that correspond to a plurality of times-series images, each data unit including information related to the object to be tracked included in the image corresponding to the data unit, and
the first determining includes fourth determining the usage dividing position based on the number of the substream data series for which the continuity of the tracking is lost when the stream data series to be divided is divided at each of the plurality of the dividing position candidates, each dividing position candidate serving as a boundary between the data units.

6. A control method executed by a control apparatus configured to send out divided data series obtained by dividing stream data series to be divided to any of a plurality of analysis apparatuses,
the stream data series to be divided including at least one substream data series, the respective substream data series including information related to an object to be tracked,
the method comprising:
determining a usage dividing position from among a plurality of dividing position candidates based on the number of the substream data series for which the continuity of the tracking is lost when the stream data series to be divided is divided at each of the plurality of the dividing position candidates that differ from one another; and
dividing the stream data series to be divided at the determined usage dividing position thereby forming the divided data series.

7. A non-transitory computer-readable medium storing a program for causing a control apparatus configured to send out divided data series obtained by dividing stream data series to be divided to any of a plurality of analysis apparatuses to perform the processes,
the stream data series to be divided including at least one substream data series, the respective substream data series including information related to an object to be tracked,
the processes comprising:
determining a usage dividing position from among a plurality of dividing position candidates based on the number of the substream data series for which the continuity of the tracking is lost when the stream data series to be divided is divided at each of the plurality of the dividing position candidates that differ from one another; and
dividing the stream data series to be divided at the determined usage dividing position thereby forming the divided data series.
